(19) United States
(12) Patent Application Publication
(10) Pub. No.: US 2024/0408978 A1
(43) Pub. Date: Dec. 12, 2024

(54) VEHICLE HAVING A LATERAL LIFTING DEVICE

(71) Applicant: BULMOR Holding GmbH, Wien (AT)

(72) Inventor: Peter SCHWEITZER, Windhaag bei Perg (AT)

(21) Appl. No.: 18/694,932

(22) PCT Filed: Sep. 23, 2022
(86) PCT No.: PCT/AT2022/060313

§ 371 Date: Mar. 22, 2024

(30) Foreign Application Priority Data
Sep. 24, 2021 (AT) A50760/2021

(51) Int. Cl. B60L 50/15; B60K 1/04; B60L 53/80; B60P 1/44; B66F 9/10

(52) U.S. Cl. CPC B60L 50/15; B60K 1/04; B60L 53/80; B60P 1/44; B66F 9/10; B60K 2001/0466

(57) ABSTRACT

A vehicle with a lateral lifting device, comprising at least a first axle carrier and a second axle carrier, wherein the two axle carriers are coupled with one another by means of a connecting structure arranged laterally off-center and wherein the lifting device is arranged in a free space between the two axle carriers. Furthermore, a power supply module with an energy carrier is configured to supply drive power, wherein a power supply module receiving means is configured which serves to receive the power supply module, wherein the power supply module is arranged changeably on the power supply module receiving means. The power supply module receiving means is configured to receive various types of power supply modules with different energy carriers.

### RELATED APPLICATIONS

This is a national stage under 35 U.S.C. § 371 of International Application No. PCT/AT2022/060313, filed Sep. 23, 2022, which claims priority of Austrian Patent Application No. A50760/2021, filed Sep. 24, 2021.

### TECHNICAL FIELD

The field of the present disclosure relates to a vehicle with lateral lifting device.

### BACKGROUND

Various embodiments of side loaders are known from EP 0 870 727 B1 and EP 2 518 010 B1.

The side loaders known from EP 0 870 727 B1 and EP 2 518 010 B1 have the disadvantage of having a not very flexible drive concept.

A further side loader is known from WO 2017/161397 A1. WO 01/79012 A2 discloses a power supply module.

A need remains for a vehicle having a lateral lifting device to provide a side loader and a method for operating a side loader with an improved drive concept.

### SUMMARY

According to the present disclosure, a vehicle is configured with a lateral lifting device. The vehicle comprises at least a first axle carrier and a second axle carrier, wherein the two axle carriers are coupled with one another by means of a laterally off-center connecting structure and wherein the lifting device is arranged in a free space between the two axle carriers. Furthermore, a power supply module with an energy carrier is configured to supply drive power, wherein a power supply module receiving means is configured which serves to receive the power supply module, wherein the power supply module is arranged changeably on the power supply module receiving means and a first plug of a power supply plug system is configured on the power supply module and a second plug of the power supply plug system is configured on the power supply module receiving means, wherein when the first plug and the second plug of the power supply plug system are plugged in a power transmission connection can be established between the power supply module and the power supply module receiving means, wherein the power supply module receiving means is configured to receive various types of power supply modules with different energy carriers.

The vehicle according to the present disclosure provides the advantage that by being able to receive different types of power supply modules with one and the same basic vehicle structure, various application and use options of the vehicle can be achieved. It is thus possible, for example, to replace an empty rechargeable battery with a full rechargeable battery to keep the vehicle's downtime to a minimum. In addition, for different areas of application, a power supply module with a rechargeable battery can be substituted for a power supply module with a combustion engine, for instance.

Moreover, it can be provided that the energy carrier is configured in the form of a rechargeable battery which is configured to store electrical energy. For instance, a wide variety of rechargeable batteries on a lithium, sodium, nickel, lead or other basis can be provided. Furthermore, it is also conceivable that a capacitor is configured as an energy carrier. According to another embodiment, the energy carrier can be a tank for a combustion engine which can, for example, be filled with petrol, diesel, methane, hydrogen, ethanol or another fuel.

According to yet another embodiment, the energy carrier can be a tank for a fuel cell which can, for example, be fillable with hydrogen. The fuel cell itself can also be part of the power supply module.

Moreover, it can be expedient for the power supply module to be configured in an L-shape when viewed from above and to be arranged above partial sections of the second axle carrier and partial sections of the connecting structure. In particular with such shaping, it is possible that the power supply module is arranged in as space-saving a way as possible in the vehicle while at the same time having as large a volume as possible in order to achieve as great a storage capacity as possible. At the same time, with such a configuration the power supply module can be easily removed from the vehicle. In particular, it can be provided that one leg of the L-shaped power supply module is arranged above partial sections of the connecting structure and that a base of the L-shaped power supply module is arranged above partial sections of the second axle carrier.

Furthermore, it can be provided that at least one crane splice is arranged on the power supply module or that a lifting fork receiving means is configured on the power supply module. This provides the advantage that the power supply module can be easily removed from or placed onto the vehicle.

Moreover, it can be provided that a control unit is configured wherein the control unit is configured in such a way that the respective type of the various types of power supply modules currently coupled with the power supply module receiving means is detectable. This provides the advantage that different vehicle settings can be configured by means of the control unit depending on the type of power supply module coupled with the vehicle. In particular, it can be provided that the type of power supply module currently coupled with the power supply module receiving means is automatically detectable by the control unit. According to an alternative embodiment, it is also conceivable that the type of power supply module is entered into the control unit by a user.

An embodiment according to which it can be provided that an information medium, in particular an RFID transponder, which serves to identify the type of power supply module is arranged on the power supply module, is advantageous. This provides the advantage that the type of power supply module can be detected automatically.

According to a further embodiment, it is possible that guide pins are arranged on the power supply module or on the power supply module receiving means, wherein the guide pins are aligned vertically, such that the power supply module can be placed onto the power supply module receiving means vertically and the guide pins serve to position the power supply module horizontally relative to the power supply module receiving means. This measure provides the advantage that the power supply module can be placed onto the power supply module receiving means in a simplified manner.

In an alternative embodiment, it can be provided that one or more guide plates are configured which serve to position the power supply modules horizontally relative to the power supply module receiving means. In particular, it can be provided that the guide plates are arranged on the corners of the power supply module receiving means and have, for example, an L-shape, such that exact positioning of the power supply module can be achieved. In particular, it can be provided that the guide plates are arranged on two opposite corners of the power supply module receiving means.

Furthermore, it can be provided that the guide plates are configured in a funnel-shaped opening manner on their side facing away from the power supply module receiving means. The placement of the power supply module onto the power supply module receiving means can thereby be simplified.

Furthermore, it can be expedient if the first plug of the power supply plug system is positioned in such a way on the power supply module and the second plug of the power supply plug system is positioned in such a way on the power supply module receiving means that when placing the power supply module onto the power supply module receiving means the power transmission connection can be established automatically. This measure provides the advantage that the method for coupling the power supply module with the power supply module receiving means can be simplified. In particular with such a configuration it can be advantageous if the aforementioned guide pins are additionally present in order to prevent damage to the power supply plug system as effectively as possible.

Moreover, it can be provided that the energy carrier is configured in the form of a fuel tank which serves to supply fuel to a combustion engine arranged on the power supply module, wherein the combustion engine is coupled with a generator also arranged on the power supply module. A power supply module with such a configuration can have a high-power output and is particularly well suited for outdoor operation of the vehicle or for long-term operation of the vehicle. In particular, it can be provided that the combustion engine is configured as a diesel engine.

According to a preferred embodiment, the combustion engine is configured as a piston engine. According to an alternative embodiment, the combustion engine can also be configured as a rotary piston engine, in particular a Wankel engine. In other embodiments it is, however, also conceivable that the combustion engine is configured as a turbine, for example.

Furthermore, it can be provided that in addition to the combustion engine and the generator, an energy storage device is arranged on the power supply module. This provides the advantage that the energy generated by the combustion engine can be buffered in the energy storage device. Furthermore, with such an embodiment it is also conceivable that the vehicle can be operated as a hybrid vehicle, wherein a purely electric drive mode is selected for travel in an indoor area, for instance, and the combustion engine can be used alternatively or additionally for power supply for travel in outdoor areas. It is hereby conceivable that a selector switch for selecting the power supply resource is arranged in the vehicle. According to an alternative embodiment, it is also conceivable that the selection of the power supply resource is performed automatically. For instance, this can be performed by determining a geofence and with the corresponding position sensing of the vehicle. Alternatively, this can also be performed by brightness sensors by means of which it can be detected whether the vehicle is in an outdoor area or indoors.

Furthermore, it can be provided that the energy storage device is configured as a rechargeable battery. For instance, a wide variety of rechargeable batteries on a lithium, sodium, nickel, lead or other basis can be provided.

According to a preferred embodiment, it is possible that a media coupling for the transmission of a fluid is configured. This provides the advantage that the power supply module can, for example, be supplied with a fluid for cooling or heating the power supply module.

According to the present disclosure, a method is configured for operating a vehicle according to one of the above embodiments. It can hereby be provided that a first type of power supply module is removed from the power supply module receiving means and replaced by a second type of power supply module.

The method has the advantage that due to the possibility of receiving different types of power supply modules with one and the same basic structure of the vehicle, various application and use options of the vehicle can be achieved. It is thus possible, for example, to replace an empty rechargeable battery with a full rechargeable battery to keep the vehicle's downtime to a minimum. In addition, for different areas of application, a power supply module with a rechargeable battery can be substituted for a power supply module with a combustion engine, for instance.

Moreover, it can be provided that the type of power supply module in place is automatically detected by means of a control unit and vehicle configurations are automatically adjusted to the type of power supply module in place. This provides the advantage that the change of the power supply module can be simplified.

### BRIEF DESCRIPTION OF THE DRAWINGS

For a better understanding of the invention, it is explained in more detail with reference to the following figures.

These show in significantly simplified, schematic representation:

FIG. 1 a perspective representation of a first example embodiment of a side loader from diagonally above;

FIG. 2 a further perspective representation of a rear side of the first example embodiment of the side loader from diagonally above;

FIG. 3 a top view of the first example embodiment of the side loader;

FIG. 4 a schematic representation of a first example embodiment of a power supply module;

FIG. 5 a schematic representation of a first example embodiment of a power supply module.

### DETAILED DESCRIPTION OF EXEMPLARY EMBODIMENTS

It is worth noting here that the same parts have been given the same reference numerals or same component configurations in the embodiments described differently, yet the disclosures contained throughout the entire description can be applied analogously to the same parts with the same reference numerals or the same component configurations.

The indications of position selected in the description, such as above, below, on the side etc. refer to the figure directly described and shown, and these indications of position can be applied in the same way to the new position should the position change.

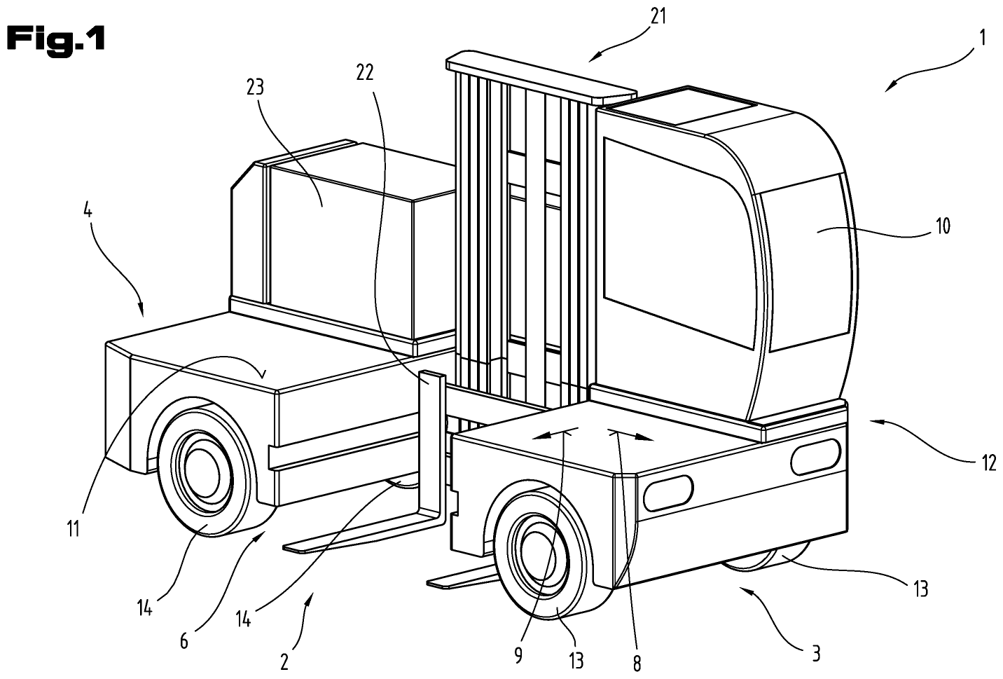

FIG. 1 shows a perspective view of a vehicle 1 with lateral lifting device 2. Such a vehicle 1 is referred to in technical language as a side loader.

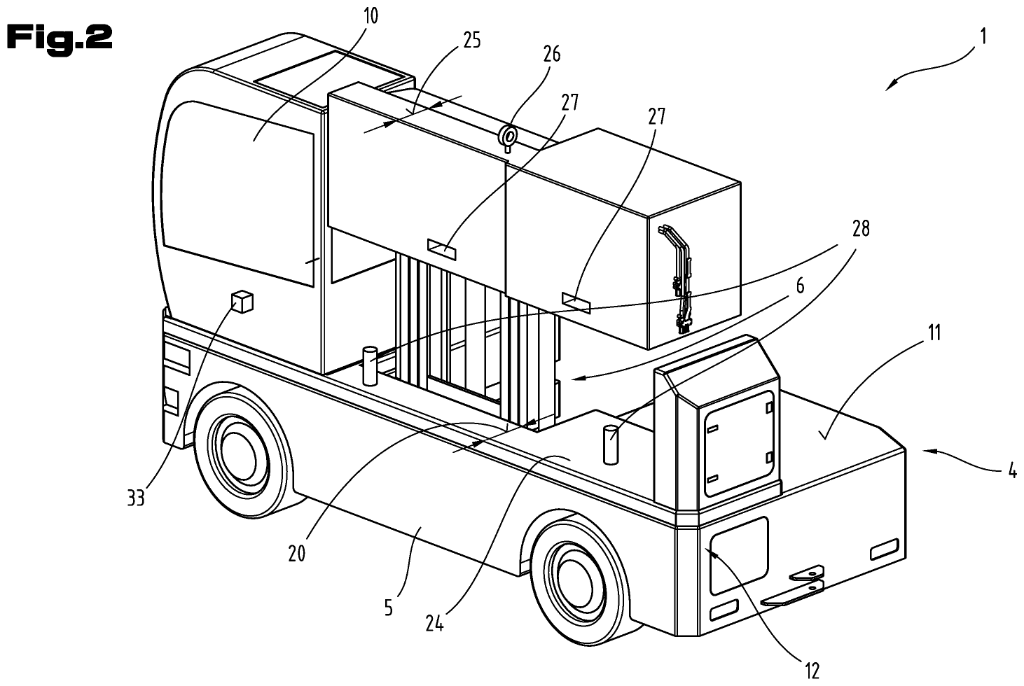

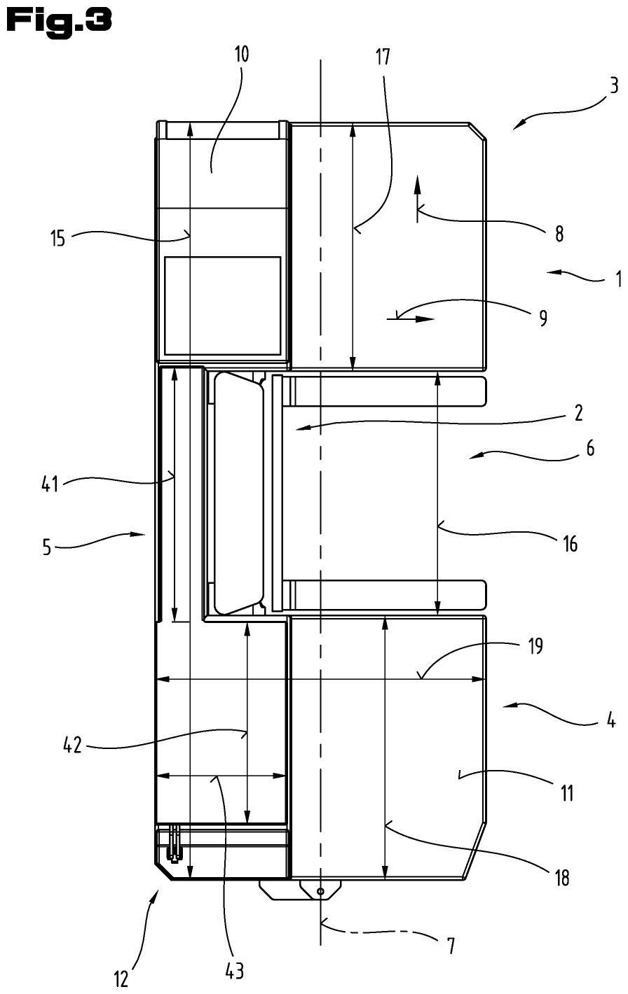

FIGS. 2 and 3 show the vehicle 1 in other representations.

The following description refers jointly to the various representations of the first example embodiment of the vehicle 1 in FIGS. 1 to 3, although not all component reference numbers are used in each of the figures, rather for the sake of clarity the components are only identified in those figures in which they are particularly visible. It is assumed that the person skilled in the art is aware of how various views from various angles are to be combined with one another.

The vehicle 1 has a first axle carrier 3 and a second axle carrier 4 which are coupled with one another by a connecting structure 5. In particular, the two axle carriers 3, 4 and the connecting structure 5 are coupled with one another in such a way that a free space 6 is formed on one side of the vehicle 1. In the top view according to FIG. 3, the vehicle 1 has a U shape, where the two parallel legs of the U are formed by the first axle carrier 3 and the second axle carrier 4.

In order to create as large a free space 6 as possible, when the vehicle 1 is viewed from above the connecting structure 5 is arranged laterally off-center. According to a preferred embodiment, the connecting structure 5 is arranged as far to a side edge 12 of the axle carriers 3, 4 as possible such that the free space 6 is as large as possible. In other words, when viewed from above the connecting structure 5 is spaced as far away from a central longitudinal axis 7 of the vehicle 1 as possible.

The longitudinal direction 8 of the vehicle 1 is defined as the direction which is parallel to the vehicle's 1 direction of movement. When viewed from above, the transverse direction 9 of the vehicle 1 is formed at a 90° angle to the longitudinal direction 8 of the vehicle 1.

Preferably, it can be provided that the vehicle 1 has a main direction of movement, whereby this is selected such that the first axle carrier 3 is at the front during forward travel, such that the first axle carrier 3 can also be referred to as the front axle carrier. Accordingly, the second axle carrier 4 can be referred to as the rear axle carrier.

Furthermore, it can be provided that a driver's cab 10 is arranged on the vehicle 1, where the driver's cab 10 is preferably arranged on the first axle carrier 3. In the embodiment of the vehicle 1 according to FIGS. 1 to 3, the driver's cab 10 is arranged on the left side of the vehicle 1 when viewed in the direction of travel. In other words, it can be provided that the driver's cab 10 is arranged on the same side of the vehicle 1 as the connecting structure 5.

Furthermore, it can be provided that a support surface 11 is arranged on the first axle carrier 3 and/or on the second axle carrier 4, upon which elongated objects picked up by the lifting device 2 can be placed. The support surface 11 can be formed by the described arrangement of the driver's cab 10 and the connecting structure 5.

The first axle carrier 3 preferably comprises a first wheel pair 13 and the second axle carrier 4 preferably comprises a second wheel pair 14.

In particular, it can be provided that the first wheel pair 13 is steered to be able to guide the vehicle 1. Furthermore, it is also conceivable that the second wheel pair 14 is steered alternatively or additionally. If both the first wheel pair 13 and the second wheel pair 14 are steered, the possible turning radius of the vehicle 1 can thereby be reduced.

When viewed from above, the axle carriers 3, 4 can have an approximately rectangular cross section.

The spacing or arrangement of the first axle carrier 3 and the second axle carrier 4 to one another not only determines a length 15 of the vehicle 1 but also a clear length 16 of the free space 6. Furthermore, it can be provided that the first axle carrier 3 has a first length 17. The second axle carrier 4 can have a second length 18. Together, the first length 17 of the first axle carrier 3, the second length 18 of the second axle carrier 4 and the clear length 16 of the free space 6 can equate to the length 15 of the vehicle 1.

Furthermore, it can be provided that the vehicle 1 has a total width 19. The connecting structure 5 can have a connecting structure width 20.

Furthermore, it can be provided that a lift mast 21 which serves to lift a lifting fork 22 is arranged in the free space 6.

All actuators for moving individual parts of the vehicle 1 and drives of the vehicle 1 can be configured in the form of electric motors. In the case of the drive, it is possible that an electric motor is configured on only one of the axle carriers 3, 4, whereby the electric motor only drives the wheel pair 13, 14 of the axle carrier 3, 4 upon which it is arranged. According to an alternative embodiment, it is also conceivable that the electric motor is arranged in the connecting structure 5 or on one of the axle carriers 3, 4 and that both wheel pairs 13, 14 of both axle carriers 3, 4 are coupled with the joint electric motor by means of a cardan shaft. According to yet another embodiment, it is also conceivable that an electric motor is configured on each of the axle carriers 3, 4, whereby the electric motors drive the respective wheel pair 13, 14 of the axle carrier 3, 4 upon which they are arranged. According to yet another embodiment, it is also conceivable that each of the individual wheels of the wheel pairs 13, 14 is coupled with its own electric motor.

Alternatively, it can also be provided that a central electric motor is coupled to a hydraulic unit and that individual or also all actuators or drives are configured in the form of a hydraulic motor.

As can be seen in FIG. 1 and particularly well in FIG. 2, it can be provided that a power supply module 23 is configured which serves to be coupled with a power supply module receiving means 24. The power supply module 23 can serve to supply drive power for the vehicle 1.

As can be seen particularly well in FIG. 2, it can be provided that the power supply module 23 is removable from the vehicle 1. In particular, it can be provided that the power supply module 23 is arranged in a section above the second axle carrier 4 or the connecting structure 5.

As can be seen in FIG. 3, it can be provided that the power supply module 23 is configured in an L-shape when viewed from above. In particular, it is conceivable here that a leg width 25 of a leg of the power supply module 23 is between 70% and 150%, in particular between 80% and 120%, preferably between 90% and 110% of the connecting structure 20.

Furthermore, it can be provided that a crane splice 26 is configured on the power supply module 23 which serves to lift the power supply module 23 by means of a lifting means.

Alternatively or additionally, it can be provided that a lifting fork receiving means 27 is received on the power supply module 23 which serves to lift the power supply module 23 by means of an industrial truck.

As can further be seen in FIG. 2, it can be provided that guide pins 28 are configured in the area of the power supply module receiving means 24 which serve to guide the power supply module 23. In particular it can be provided that corresponding guide bores are arranged in the power supply module 23 with the guide pins 28.

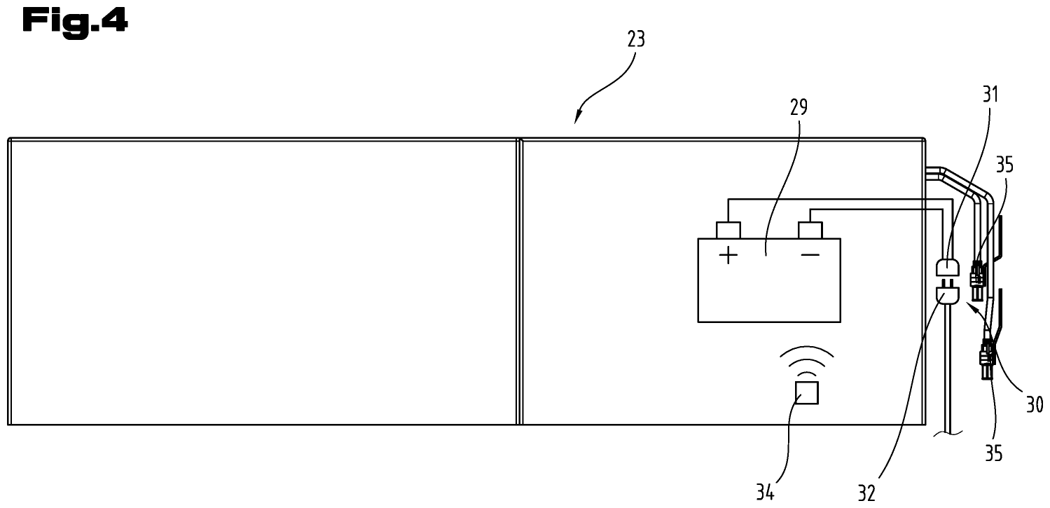

In FIG. 4, a further and possibly independent embodiment of the power supply module 23 is shown, again using the same reference numerals or component designations for the same parts as in the preceding FIGS. 1 to 3. To avoid unnecessary repetition, reference is made to the detailed description in the preceding FIGS. 1 to 3.

As can be seen in FIG. 4, it can be provided that an energy carrier 29 is arranged in the power supply module 23. In the present example embodiment, the energy carrier 29 can be configured as a rechargeable battery. The energy carrier 29 can be coupled with the vehicle 1 by means of a power supply plug system 30 or contact plates (spring pre-loaded). In particular, it can be provided that the power supply plug system 30 has a first plug 31 which is coupled with the energy carrier 29. Furthermore, the power supply plug system 30 can have a second plug 32 which can be coupled with the vehicle 1. When the first plug 31 and the second plug 32 are plugged in, the vehicle 1 can have an electrically conductive connection with the energy carrier 29.

According to a first embodiment, it is conceivable that the first plug 31 and the second plug 32 can be manually connected with one another after placing the power supply module 23 onto the power supply module receiving means 24.

According to an alternative embodiment, it is also conceivable that the first plug 31 and the second plug 32 are arranged on the power supply module 23 or in the area of the power supply module receiving means 24 in such a way that when placing the power supply module 23 onto the power supply module receiving means 24 the first plug 31 is automatically coupled with the second plug 32.

According to an alternative embodiment, it is also conceivable that the energy carrier 29 is coupled with the vehicle 1 by means of a contact system. The contact system can, for example, comprise two or more contact plates which interact with corresponding counterplates. The contact plates can, for example, be configured to be sprung or comprise spring elements. A secure contact between the contact plates and the counterplates to the electrical cables can thereby be achieved.

Furthermore, it can be provided that a control unit 33 is configured on the vehicle 1 which can comprise a digital computer. The displacements or work movements of the vehicle 1 can be controlled by means of the control unit 33. It is further conceivable that an energy management system is controlled or provided by means of the control unit 33.

As can further be seen in FIG. 4, it can be provided that an information medium 34 is arranged on the power supply module 23. The information medium 34 can serve to clearly identify the type of power supply module 23. According to a further embodiment, it is also conceivable that the information medium 34 serves to clearly identify each of the possible power supply modules 23.

The information medium 34 can, for example, be configured as a wirelessly operating data medium, such as an RFID transponder. According to an alternative embodiment, it is also conceivable that the information medium 34 is coupled with the first plug 31 or is installed in the first plug 31 such that an identification of the power supply module 23 can be performed by means of the power supply plug system 30.

According to yet another embodiment, it is also conceivable that a machine-readable code is arranged on the power supply module 23 which can be read by a reader unit arranged on the vehicle 1.

According to yet another embodiment, it is also conceivable that when changing the power supply module 23 the type of power supply module 23 is entered into the control unit 33 by the machine operator manually navigating the menu.

According to yet another embodiment, it is also conceivable that an identification of the power supply module 23 can be achieved using a mechanical code system such as a hole pattern which interacts with binary transmitters.

As can further be seen in FIG. 4, it can be provided that a media coupling 35 for transmitting a fluid is coupled with the power supply module 23. The media coupling 35 can, for example, serve to transmit a coolant to cool the energy carrier 29. As with the power supply plug system 30, it can also be provided that the media coupling 35 is manually or, with the corresponding arrangement, automatically coupled with the vehicle 1. According to a further embodiment, it can also be provided that the media coupling 35 is integrated in the power supply plug system 30.

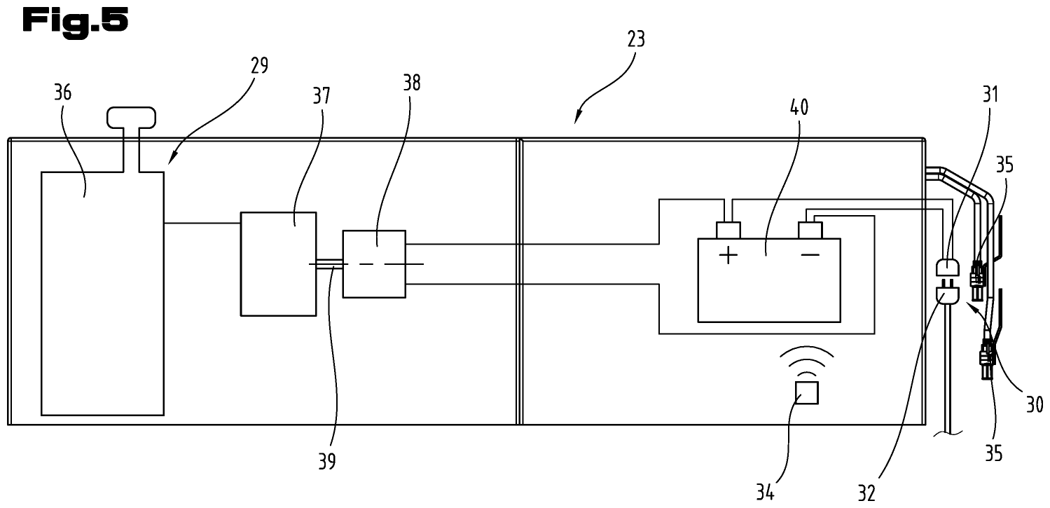

In FIG. 5, a further and possibly independent embodiment of the power supply module 23 is shown, again using the same reference numerals or component designations for the same parts as in the preceding FIGS. 1 to 4. To avoid unnecessary repetition, reference is made to the detailed description in the preceding FIGS. 1 to 4.

As can be seen in FIG. 5, it can be provided that the power supply module 23 has an energy carrier 29 in the form of a fuel tank 36. The fuel tank 36 can serve to supply a combustion engine 37 with fuel. Furthermore, it can be provided that the combustion engine 37 is coupled by means of a drive shaft 39 with a generator 38 to generate electrical energy. The generator 38 can be coupled with the vehicle 1 in an electrically conductive manner by means of the power supply plug system 30. Furthermore, it is also conceivable that an energy storage device 40, for example in the form of a rechargeable battery, which can also be coupled with the generator 38 in an electrically conductive manner, is configured on the power supply module 23.

Due to the configuration of the power supply module 23 or the exchangeability of the power supply module 23, one and the same vehicle 1 can be used for different areas of application. If, for instance, a vehicle with increased performance is required, it is conceivable that a power supply module 23 with a combustion engine 37 as described in FIG. 5 is installed, for example. If, however, a vehicle 1 ought to emit as little noise or emissions as possible, it is conceivable that a power supply module 23 with a rechargeable battery as energy carrier 29 is installed on the vehicle 1, as described in FIG. 4.

As can further be seen in FIG. 3, it can be provided that a leg of the power supply module 23 has a leg length 41. The leg length 41 can be between 80% and 120%, in particular between 90% and 110%, preferably between 98% and 105% of the clear length 16.

Furthermore, it can be provided that a base of the power supply module 23 has a basic length 42 and a basic width 43. The basic length 42 can be between 50% and 100%, in particular between 70% and 90%, preferably between 75% and 85% of the second length 18 of the second axle carrier 4. The basic width 43 can be between 10% and 100%, in particular between 15% and 50%, preferably between 25% and 35% of the total width 19 of the vehicle 1.

The example embodiments show possible embodiment variations, although it is to be noted here that the invention is not limited to the specifically represented embodiment variations of the same, but rather various combinations of the individual embodiment variations with one another are possible, and that given the technical teachings provided by the present disclosure this variation possibility is within the ability of the skilled person in this technical field.

The scope of protection is defined by the claims. The description and the drawings should, however, be consulted when construing the claims. Individual features or combinations of features from the various example embodiments as shown and described can constitute separate inventive solutions. The problem to be solved by the individual inventive solutions can be derived from the description.

All value ranges specified in the current description are to be understood such that they include any and all sub-ranges, e.g., the specification 1 to 10 is to be understood such that all sub-ranges, starting from the lower limit 1 and the upper limit 10 are included, i.e., all sub-ranges begin with a lower limit of 1 or more and end at an upper limit of 10 or less, e.g., 1 to 1.7, or 3.2 to 8.1, or 5.5 to 10.

As a matter of form and by way of conclusion, it is noted that, to improve understanding of the structure, elements have partially not been shown to scale and/or enlarged and/or shrunk.

1. A vehicle with a lateral lifting device, comprising at least a first axle carrier and a second axle carrier, wherein the two axle carriers are coupled with one another by means of a connecting structure arranged laterally off-center and wherein the lifting device is arranged in a free space between the two axle carriers, wherein a power supply module with an energy carrier is configured to supply drive power, wherein a power supply module receiving means is configured which serves to receive the power supply module, wherein the power supply module is arranged changeably on the power supply module receiving means and a first plug of a power supply plug system is configured on the power supply module and a second plug of the power supply plug system is configured on the power supply module receiving means, wherein when the first plug and the second plug of the power supply plug system are plugged in, a power transmission connection can be established between the power supply module and the power supply module receiving means, wherein the power supply module receiving means is configured to receive various types of power supply modules with different energy carriers.

2. The vehicle according to claim 1, characterized in that when viewed from above the power supply module is configured in an L-shape and is arranged above partial sections of the second axle carrier and partial sections of the connecting structure.

3. The vehicle according to claim 1, characterized in that at least one crane splice is arranged on the power supply module or in that a lifting fork receiving means is configured on the power supply module.

4. The vehicle according to claim 1, characterized in that a control unit is configured, wherein the control unit is configured in such a way that the respective type of the various types of power supply modules currently coupled with the power supply module receiving means is detectable.

5. The vehicle according to claim 4, characterized in that an information medium, in particular an RFID transponder, is arranged on the power supply module, which serves to identify the type of power supply module.

6. The vehicle according to claim 1, characterized in that guide pins are arranged on the power supply module or on the power supply module receiving means, wherein the guide pins are aligned vertically, such that the power supply module can be placed onto the power supply module receiving means vertically and the guide pins serve to position the power supply module horizontally relative to the power supply module receiving means.

7. The vehicle according to claim 1, characterized in that the first plug of the power supply plug system is positioned in such a way on the power supply module and the second plug of the power supply plug system is positioned in such a way on the power supply module receiving means that when placing the power supply module onto the power supply module receiving means the power transmission connection can be established automatically.

8. The vehicle according to claim 1, characterized in that the energy carrier is configured in the form of a fuel tank which serves to supply fuel to a combustion engine arranged on the power supply module, wherein the combustion engine is coupled with a generator also arranged on the power supply module.

9. The vehicle according to claim 8, characterized in that in addition to the combustion engine and the generator, an energy storage device is arranged on the power supply module.

10. The vehicle according to claim 1, characterized in that a media coupling is configured for the transmission of a fluid.

11. A method for operating a vehicle according to claim 1, wherein a first type of the power supply module is removed from the power supply module receiving means and replaced by a second type of the power supply module.

12. The method according to claim 11, characterized in that the type of power supply module in place is automatically detected by means of a control unit and vehicle configurations are automatically adjusted to the type of power supply module in place.
